(19) United States
(12) Patent Application Publication
(10) Pub. No.: US 2018/0077951 A1
(43) Pub. Date: Mar. 22, 2018

(54) ANIMAL FEED SUPPLEMENT

(71) Applicant: KEMIN INDUSTRIES, INC., Des Moines, IA (US)

(72) Inventors: Matias JANSEN, Oevel (BE); Filip NUYENS, Geel (BE); Ilse MAST, Lint (BE)

(21) Appl. No.: 15/706,040

(22) Filed: Sep. 15, 2017

Related U.S. Application Data
(60) Provisional application No. 62/454,311, filed on Feb. 3, 2017.
(60) Provisional application No. 62/395,449, filed on Sep. 16, 2016.

(51) Int. Cl. A23K 20/158; A23K 20/163

(52) U.S. Cl. CPC A23K 20/158; A23K 20/163

(57) ABSTRACT

An animal feed supplement composition comprising a combination of lysolecithin or purified lysophospholipid-rich compounds, monoglycerides and at least one synthetic emulsifier in amounts sufficient to enhance nutrient digestibility, absorption or utilization of feed.

### RELATED APPLICATIONS

This application claims the benefit of priority to U.S. Provisional Patent Application No. 62/454,311, filed Feb. 3, 2017, and claims the benefit of priority to U.S. Provisional Patent Application No. 62/395,449, filed Sep. 16, 2016, both of which are hereby incorporated by reference in their entireties.

### BACKGROUND OF THE INVENTION

The present invention relates generally to animal feed supplements and, more specifically, to an animal feed supplement that is a synergistic combination of ingredients that improves the digestibility and absorption of fats and other nutrients from the animal feed.

The quest to raise livestock with high quality feed at the lowest possible cost presents great challenges in modem livestock production. On one hand, modern livestock breeds are fast growing and highly efficient at converting feed into meat, eggs or milk. On the other hand, efficient conversion requires an ample supply of nutrients Increasing feed costs and the availability of alternative feed raw materials urge livestock producers to use reformulated diets that are more economical, but also harder for the livestock to digest. Due to their high energy concentration, large amounts of fats and oils are commonly added to the feed to fulfil the increasing daily energy requirements. This high fat content feed typically presents challenging dietary conditions for livestock. Therefore, there is a need for feed additives that can improve the digestibility and absorption of fats and other nutrients from the feed in the modern livestock production industry.

Lysolecithins have been used for many years to improve the digestibility and absorption of nutrients, especially fats, from the feed. It is postulated that lysolecithins supplemented through the feed, together with bile salts, act as an emulsifier within the first stages of lipid digestion (Zhang et al., 2011; AT4.1). By increasing the surface-to-volume ratio of the fat in the intestinal tract, lysolecithins are thought to increase the total available surface area for lipases to attach to the fat droplet interface and thus increase the lipid hydrolysis. Additionally, recently it has been proposed that lysolecithins are able to participate in the formation of mixed micelles (Jansen, 2015; AT4.2). In this way, lysolecithins may play a critical role by displacing the products of lipid hydrolysis (monoglycerides and free fatty acids) from the droplet interface, allowing lipid hydrolysis to continue. Lastly, lysolecithins are known to improve the absorption of lipids and possibly other nutrients (Jansen, 2015; AT4.2). It is not known if lipid absorption is a secondary effect of the lysolecithin interference with micelle formation or the result of a direct interaction of lysolecithins with the enterocyte membrane or the enterocyte membrane proteins.

Monoglycerides are generated during the lipid hydrolysis process in the animal (Lairon, 2009; AT 4.3). During the digestion process of fats and oils, the colipase-lipase-complex first hydrolyses triglycerides into diglycerides and free fatty acids. In a next step, the colipase-lipase-complex hydrolyses the diglycerides into monoglycerides and free fatty acids. These monoglycerides and free fatty acids then arrange into the mixed micelles that are subsequently absorbed by the enterocytes of the small intestine. Monoglycerides have a very wide application range. In the food industry they are used in baked goods, confectionery, margarines, juices and dairy products where they can function as a binding compound, antifoaming agent, flavoring agent, stabilizer, thickener, lubricant and texturizer. In the cosmetic industry, monoglycerides are used in different oils, ointments and moisturizing creams where they function as a spreading and (water-in-oil) emulsifying agent. Other uses of monoglycerides include the PVC, pharmaceutical and textile industry.

The use of monoglycerides in the feed industry is limited. Specific monoglycerides esterified with short chain fatty acids (<7 carbon atoms) are used as an anti-mold and antimicrobial agent (WO2010/106488; AT4.4). Monoglycerides with longer chain lengths (>7 carbon atoms) are mostly used as a technical aid to physically stabilize formulations. To our knowledge, there exists one commercially available feed additive that includes a specific monoglyceride (glycerol monostearate) and claims to increase the digestion and absorption of nutrients in animals (LipidMate; AT4.5). However, there is no literature available on the mode of action exhibited by these monoglycerides when added to the feed to increase nutrient digestion and absorption. Additionally, high inclusion levels (80-100 grams per ton of feed) are proposed by the manufacturer to achieve these improvements and the product does not contain lysolecithin and/or glycerol polyethyleneglycol ricinoleate.

A synthetic emulsifier that is typically used in the feed industry is glycerol polyethyleneglycol ricinoleate (E484; Community Register of Feed Additives—EU Reg. No. 1831/2003). Glycerol polyethyleneglycol ricinoleate is composed of triglyceride backbone in which the fatty acids have been ethoxylated in an industrial process. Depending on the process conditions, the degree of ethoxylation can vary between 8 and 200 ethylene oxide groups. Glycerol polyethyleneglycol ricinoleate is the main constituent of ethoxylated castor oil. Ethoxylated castor oil is commercialized as a feed additive to increase the digestion of nutrients in animals. High inclusion levels (200-500 grams per ton of feed) are proposed by the manufacturers to achieve these improvements. It is postulated that these synthetic emulsifiers also act as an emulsifier within the first stages of lipid digestion, increasing the surface-to-volume ratio of the fat in the intestinal tract (Excential Energy Plus; AT4.6). However, there is a trade-off between increased emulsification of the fat and steric hindrance of the emulsifying components adhered to the lipid droplet interface. If too many synthetic emulsifiers are adhered to the lipid droplet interface, the relatively large glycerol polyethyleneglycol ricinoleate molecule can physically hinder the attachment of the colipase-lipase complex to the droplet interphase.

### SUMMARY OF THE INVENTION

A product formula is discovered consisting of (1) lysolecithin or purified lysophospholipid-rich compounds, (2) monoglycerides and (3) synthetic emulsifier or mixtures of synthetic emulsifiers. The product is useful as a feed additive because it enhances nutrient digestibility, absorption and utilization. Moreover, the formula has several positive physiological effects that exceed the benefits from lysolecithin, monoglycerides or synthetic emulsifiers alone.

### BRIEF DESCRIPTION OF THE DRAWINGS

FIG. 1 is a chart of the accumulation of free fatty acids during the in vitro hydrolysis of animal fat (Control), animal fat with lysolecithin, animal fat with a mixture of lysolecithin, glycerol monooleate and synthetic emulsifier (Mixture A) and animal fat of a mixture of lysolecithin, glycerol monostearate and synthetic emulsifier (Mixture B); the experimental treatments were carried out in triplicate; the mean concentrations of the lipids (mg/ml) are given over time (min), with error bars indicating the standard error values.

FIG. 2 is a chart of the free fatty acid release rate expressed as the apparent rate constant (k) for the in vitro hydrolysis of animal fat (Control), animal fat with lysolecithin, animal fat with a mixture of lysolecithin, glycerol monooleate and synthetic emulsifier (Mixture A) and animal fat of a mixture of lysolecithin, glycerol monostearate and synthetic emulsifier (Mixture B); data are means of three observations per treatment, with error bars indicating the standard error values.

FIG. 3 is a chart of the absorption of monoglycerides and free fatty acids generated during in vitro hydrolysis of animal fat (Control), animal fat with lysolecithin, animal fat with a mixture of lysolecithin, glycerol monooleate and synthetic emulsifier (Mixture A) and animal fat of a mixture of lysolecithin, glycerol monostearate and synthetic emulsifier (Mixture B) by differentiated Caco-2 monolayers and expressed as percentage of applied monoglycerides end free fatty acids; data are means of three observations per treatment, with error bars indicating the standard error values.

### DESCRIPTION OF THE INVENTION

Lysolecithins are prepared by the enzymatic hydrolysis of lecithin. Lysolecithins typically have a total amount of lysophospholipids between 45 and 180 g/kg of which 20 to 80 g/kg lysophosphatidylcholine, 10 to 40 g/kg lysophosphatidylethanolamine, 10 to 40 g/kg lysophosphatidylinositol and 5 to 20 g/kg lysophosphatidic acid (WP-08-00120; AT4.8). The inclusion rates of lysolecithin in animal feed range typically from 50 to 250 grams per ton of feed, although other inclusions may be used depending on dietary conditions and animal species. To achieve the desired effects, the inclusion rates of feed additives based on ethoxylated castor oil range typically from 200 to 500 grams per ton of animal feed. Similarly, an inclusion rate of between 100 to 150 grams per ton of animal feed for a feed additive based on monoglycerides has been proposed.

The current invention discloses that a typical inclusion rate of lysolecithins, for example 150 grams per ton of feed, can be supplemented with minor amounts of monoglycerides, for example 25 grams per ton, and synthetic emulsifiers, for example 2.5 grams per ton, to further enhance the improvements obtained with lysolecithins. The inclusion levels of monoglycerides and synthetic emulsifier in the current invention are well below the typically used inclusion rates. Nevertheless, the combination of lysolecithin, monoglycerides and synthetic emulsifier has resulted in an unexpected and synergistic reaction providing positive physiological effects that exceed the benefits from lysolecithin, monoglycerides or synthetic emulsifiers alone.

Due to the unexpected nature of the synergistic events, the exact mode of action of a mixture of lysolecithin, monoglycerides and synthetic emulsifier is not known at the moment of the invention. It can be postulated that in addition to the known impact of lysophospholipids on the lipid emulsification, small quantities of synthetic emulsifier molecules further optimize emulsification of lipids in the feed.

Furthermore, the excellent emulsifying properties of synthetic emulsifiers may improve the release of lipids from the feed matrix and in this way improve the extent and rate of coverage of lipids in the feed by the lysophospholipids in the additive.

The changes in environmental conditions (e.g., release of bile salts from the gall bladder) that accompany the entrance of the lipid droplets into the duodenum initiate the displacement of lysophospholipids from the droplet interphase towards the formation of mixed micelles. The presence of small quantities of monoglycerides may further enhance this displacement for the “initial” micelle formation, as monoglycerides and fatty acids are needed in addition to lysophospholipids and bile salts. Small quantities of free fatty acids are generally already generated by the hydrolysis of triglycerides into diglycerides and free fatty acids during the pre-duodenal phase of lipid digestion. Monoglycerides, however, are only formed by the hydrolysis of diglycerides which typically occurs in the small intestine of the animal. Through the synergistic action of lysophospholipids and monoglycerides during the initial micelle formation, the monoglycerides thus may play a critical role by displacing the hydrolysis products from the interface and allowing lipid hydrolysis to continue

Another interaction between lysophospholipids from lysolecithin and monoglycerides may be seen at the droplet interface when bile salts enter the droplet interface. A direct interaction between the polar headgroup of surface active molecules, such as (lyso)phospholipids and monoglycerides, and bile salts has been observed (Dreher et al., 1967; AT4.9). The interaction allows the hydrophobic face of the bile salts to rotate and come into closer contact with the interface. The combined interaction of lysophospholipids and monoglycerides with bile salts may improve the attachment of bile salt to the lipid droplet, which in turn will improve the hydrolysis rate.

Lastly, as described for lysophospholipids, the absorption of lipids and possibly other nutrients may further be improved as a secondary effect of the interference of monoglycerides and lysophospholipids with micelle formation.

Considering that the amount of lipids in different feeds can vary to great extent and considering that the inclusion rate of compounds targeting the improvement and absorption of nutrients is typically related to the amount of lipids in the feed, the current invention relates to the use of a combination of lysolecithin at an inclusion rate between 15 and 1500 grams per ton, monoglycerides at an inclusion rate between 2.5 and 250 grams per ton and synthetic emulsifier at an inclusion rate of 0.25 to 25 grams per ton of feed.

Lysolecithins, monoglycerides and synthetic emulsifiers can be applied separately to the feed batch, combined in a single premixture or as a preparation of premixtures. The products, either separately or combined, can be applied as liquids or put on a suitable carrier (example silica or vegetable fiber fractions) and applied as dry products.

Lysophospholipids are the active components in lysolecithin. Hence, in the present invention instead of lysolecithin, lysophospholipids could be added to the premixture or feed as purified or concentrated components as well.

Monoglycerides are composed of a glycerol group that is esterified at position sn-1, sn-2 or sn-3 with a fatty acid. The present invention relates to monoglycerides or mixtures of monoglycerides containing fatty acids with chain lengths between 1 and 24 carbon atoms, either without double bonds or with one or more double bonds. Related to the number of double bonds in the monoglycerides, the monoglycerides considered in this invention include those with iodine value between 0 and 200 gI2/100 g.

Synthetic emulsifiers considered in this invention specifically relate to glycerol polyethyleneglycol ricinoleate (E484) containing 8 to 200 ethylene oxide groups. The present invention relates in extension to all emulsifiers, including but not limited to emulsifiers as approved in the Community Register of Feed Additives (EU Reg. No. 1831/2003) such as polyethyleneglycol esters of fatty acids from soya oil (E487) and sorbitan monolaurate (E493). Related to the molecular structure of the emulsifiers, the emulsifiers considered in this invention include those with a hydrophilic-lipophilic balance (HLB-value) between 2 and 20.

### Example 1: A Combination of Lysolecithin. Monoglycerides and Synthetic Emulsifier to Improve In Vitro Lipid Hydrolysis

At the Kemin Europa NV research facilities (Herentals, Belgium) an in vitro lipid hydrolysis model was employed to evaluate the impact of mixtures of lysolecithin, monoglycerides and synthetic emulsifier on in vitro lipid hydrolysis samples.

### Materials and Methods

Animal Fat, Lysolecithin, Monoglycerides and Synthetic Emulsifier.

A sample of animal fat, destined for use in animal feed, was provided by the Institute for Agricultural and Fisheries Research (ILVO, Merelbeke, Belgium). Lysolecithin (hydrolysed soybean lecithin with a total lysophospholipid content of 124.9 g/kg), glycerol monooleate (fatty acid with 18 carbon atoms and one double bond; Iodine value of 75.8 g I₂/100 g), glycerol monostearate (fatty acid with 18 carbon atoms without double bonds; Iodine value of 0.6 g I₂/100 g) and synthetic emulsifier (Ethoxylated castor oil containing on average 40 ethylene oxide groups and with a HLB value of 12.5) were used to prepare the mixtures.

Mixtures of Lysolecithin Monoglycerides and a Synthetic Emulsifier.

Two mixtures, indicated as Mixture A and Mixture B (Table 1), were prepared by accurately weighing all components together. Next, Mixture A was stirred at approximately 250 RPM for 30 minutes using a magnetic stirrer. Due to the difference in viscosity of the monoglycerides, Mixture B was first heated to 60° C. and then stirred at approximately 250 RPM for 30 minutes.

TABLE 1
Overview of the contents in Mixture A and Mixture B

| Component | Mixture A (g) | Mixture B (g) |
|---|---|---|
| Lysolecithin | 84.5 | 84.5 |
| Glycerol monooleate | 14.1 | / |
| Glycerol monostearate | / | 14.1 |
| Synthetic emulsifier | 1.4 | 1.4 |

Experimental Treatments.

1.20 g of lysolecithin, 1.42 g of Mixture A and 1.42 g of Mixture B were each dispersed in 100.00 g of animal fat to prepare the stock fat dispersions. In this way, the final lysolecithin contents in the three experimental treatments are identical (Table 2). Moreover, the Mixture A and Mixture B treatments only differ in the type of monoglyceride included (Table 1 and Table 2).

TABLE 2
Overview of the stock fat dispersions for evaluation of lipid hydrolysis

| | Active component (g) | | | |
|---|---|---|---|---|
| Treatment | | | Synthetic | Animal |
| ID | Lysolecithin | Monoglyceride | emulsifier | fat (g) |
| Control | / | / | / | 100.00 |
| Lysolecithin | 1.20 | / | / | 100.00 |
| Mixture A | 1.20 | 0.20 glycerol | 0.02 | 100.00 |
| | | monooleate | | |
| Mixture B | 1.20 | 0.20 glycerol | 0.02 | 100.00 |
| | | monostearate | | |

Lipid Hydrolysis Model.

The lipid hydrolysis model previously described by Jansen et al. (2015) was used to evaluate the effect of the components on lipid hydrolysis. Fasted state simulated intestinal fluid (FaSSIF) was prepared by adding 2.24 g of FaSSIF powder (Biorelevant.com Ltd, Croydon, United Kingdom) to 1 L of phosphate buffer (35 mM, pH 6.5) containing 106 mM NaCl. Aliquots of 0.25 g of each of the respective stock fat treatments (Table 2) and 14.75 ml of FaSSIF were added into 50 ml centrifuge tubes. The content of each tube was mixed for 30 s with a high shear mixer (24000 RPM; IKA ULTRA-TURRAX T18, Staufen, Germany). Next, 24 mg of pancreatin (P7545, Sigma Aldrich) was added to each tube and they were incubated for two hours at 40° C. while shaking (250 RPM). The final contents in the digests were 106 mM NaCl, 1.6 g/L pancreatin, 1.6 g/L bile salts and 16.7 g/L animal fat. At 0, 15, 30, 60, 90 and 120 min of incubation, a 0.5 ml sample of each digest was taken and diluted in 9.5 ml tetrahydrofuran (THF, HPLC grade, VWR International, Leuven, Belgium) to inactivate the enzymes and prepare the appropriate dilution for lipid analysis. Each digestion was performed in triplicate. At the end of the incubation, hydrolysis samples of the control treatment, the Mixture A treatment and the Mixture B treatment were submerged in liquid nitrogen and stored at −80° C. (see Example 2).

Lipid Analyses.

In each sample obtained during the in vitro lipid digestion, the degree of lipid hydrolysis was analyzed by HPLC. The free fatty acids were determined by gel permeation chromatography (column PL 1110-6520, 5 μm 100 A 300×7.5 mm, Agilent Technologies, Diegem, Belgium) with Evaporative Light Scattering Detector (ELSD 85, VWR International). THF was used as the mobile phase at a flow rate of 0.5 ml/min.

Calculations and Statistical Analyses.

The following first-order kinetic model, previously used by Jansen et al. (2015) to analyze digestibility data, was applied to the data obtained for free fatty acid release during in vitro digestion:

$$ln ( \frac{{C}_{max} - {C}_{t}}{{C}_{t}} ) = - k \times t$$

where k (min⁻¹) is the apparent rate constant for free fatty acid release, Cₜ is the amount (mg/ml) of free fatty acids released at a given digestion time t (min) and Cₘₐₓ is the maximum amount (mg/ml) of free fatty acids released. To determine the apparent rate constant (k), ln((Cₘₐₓ−Cₜ)/Cₘₐₓ) was plotted against t.

The apparent rate constants for free fatty acid release were subjected to analysis of variance (ANOVA). ANOVA of the experimental treatments was done with STATGRAPHICS Centurion XVI software (Statpoint Technologies Inc., Warrenton, Va.), and means were separated by the least significant differences (LSD) procedure. All statements of significance were based on a P-value equal to or less than 0.05.

### Results

Lipid hydrolysis.

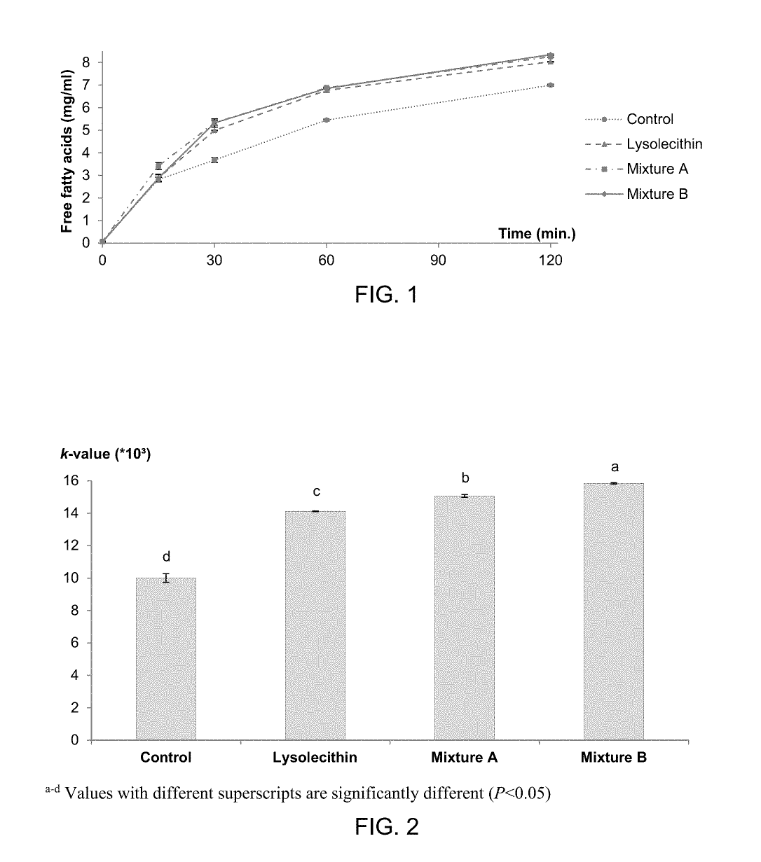

The accumulation of free fatty acids during the in vitro hydrolysis of animal fat, animal fat with 1.2% lysolecithin, animal fat with 2% lysolecithin, animal fat with Mixture A and animal fat with Mixture B are shown in FIG. 1. Over the whole incubation period of 120 minutes, the amounts of free fatty acids accumulated in both Mixture A and Mixture B were markedly higher than those animal fat and animal fat with lysolecithin.

The apparent first-order rate constants for free fatty acid release (k) were 10.00×10⁻³ min⁻¹, 14.12×10⁻³ min⁻¹, 15.06×10⁻³ min⁻¹ and 15.84×10⁻³ min⁻¹ for the in vitro hydrolysis of animal fat (Control), animal fat with lysolecithin, animal fat with a mixture of lysolecithin, glycerol monooleate and synthetic emulsifier (Mixture A) and animal fat of a mixture of lysolecithin, glycerol monostearate and synthetic emulsifier (Mixture B), respectively. A comparison of the apparent first-order rate constants for the accumulation of free fatty acids for each treatment is presented in FIG. 2.

The addition of lysolecithin, the addition of Mixture A and the addition of Mixture B had a significant (P<0.05) impact on the free fatty acid release rate. Addition of lysolecithin increased the free fatty acid release rate by 41%. Even though the same amounts of lysolecithin were added, Mixture A and Mixture B were more successful in increasing free fatty acid release rate. Addition of Mixture A and Mixture B increased the free fatty acid release rate by 50% and 58% respectively.

### Example 2: A Combination of Lysolecithin. Monoglycerides and Synthetic Emulsifier to Improve In Vitro Lipid Absorption

At the Kemin Europa NV research facilities (Herentals, Belgium) a cell culture based model was developed to evaluate the effect of different compounds on in vitro lipid absorption. To evaluate the impact of mixtures of lysolecithin, monoglycerides and synthetic emulsifier on in vitro lipid absorption the hydrolysis samples (see Example 1) were applied to differentiated Caco-2 monolayers.

### Materials and Methods

Mixtures of Lysolecithin Monoglycerides and a Synthetic Emulsifier.

A mixture of lysolecithin, glycerol monooleate and synthetic emulsifier (Mixture A, Table 1) and a mixture of lysolecithin, glycerol monostearate and synthetic emulsifier (Mixture B, Table 1) were evaluated in this experiment (see Example 1).

Experimental Treatments.

Hydrolysis samples obtained at the end of the in vitro hydrolysis of animal fat (Control), animal fat with Mixture A and animal fat with Mixture B (see Example 1) were submerged in liquid nitrogen and stored at −80° C. until absorption experiments.

Cell Culture.

Human colonic adenocarcinoma cells (Caco-2) were obtained from the European Collection of Cell Cultures (Public Health England, Porton Down, Salisbury, UK). Caco-2 cell work stock was used between passages 54 and 60. Cells were cultured in Dulbecco's modified eagle medium supplemented with 10% heat-inactivated fetal bovine serum (Hyclone, Thermo scientific, Leuven, Belgium), 1% non-essential amino acids, 100 U/ml of penicillin and 100 U/ml of streptomycin. The cells were maintained at 37° C. in a humidified atmosphere of 5% CO₂ and routinely passaged. Unless stated otherwise, the cell culture media and supplements were provided by Westburg (Leusden, The Netherlands).

Lipid Absorption Model.

Caco-2 cells were seeded on collagen-coated Transwell-COL inserts (1.12 cm², pore size 0.4 Cpm, Corning Costar Corporation, Cambridge, Mass.) in 24-well plates at a density of 2.5×10⁵ cells per insert and incubated for 21 days to allow the cells to differentiate. During incubation, the medium (apical and basal) was changed three times a week and the trans-epithelial electrical resistance (TEER) was monitored (Millicell-ERS, Millipore, Overijse, Belgium). Next, the different hydrolysis samples obtained with the lipid hydrolysis model (Example 1) were diluted 25-fold in FaSSIF and applied at the apical side of the monolayer. Simultaneously, Eagle's minimum essential medium (EMEM) with 5% heat-inactivated fetal bovine serum, 2% L-glutamine and 1% non-essential amino acids was applied at the basal side of the monolayer. At the start and after 60 minutes of incubation, a sample of the apical fluid was taken and diluted twofold in THF and subjected to lipid analysis. Each absorption experiment performed in three replicates.

Lipid Analyses.

In each sample obtained during the in vitro lipid absorption, the amount of monoglycerides and free fatty acids was analyzed by HPLC. Monoglycerides and free fatty acids were determined by gel permeation chromatography (column PL 1110-6520, 5 μm 100 A 300×7.5 mm, Agilent Technologies, Diegem, Belgium) with Evaporative Light Scattering Detector (ELSD 85, VWR International). THF was used as the mobile phase at a flow rate of 0.5 ml/min.

Calculations and Statistical Analyses.

The absorption of monoglycerides (%) in each well was calculated as follows:

$$monoglyceride absorption = \frac{{MG}_{0} - {MG}_{60}}{{MG}_{0}} \times 100$$

where MG₀ and MG₆₀ are the respective monoglyceride contents (mg/ml) before and after 60 minutes of incubation. Correspondingly, free fatty acid absorption (%) was calculated from the respective free fatty acid contents.

The monoglyceride and free fatty acid absorption values were subjected to analysis of variance (ANOVA). ANOVA of the experimental treatments was done with STATGRAPHICS Centurion XVI software (Statpoint Technologies Inc., Warrenton, Va.), and means were separated by the least significant differences (LSD) procedure. All statements of significance were based on a P-value equal to or less than 0.05.

### Results

Lipid Absorption.

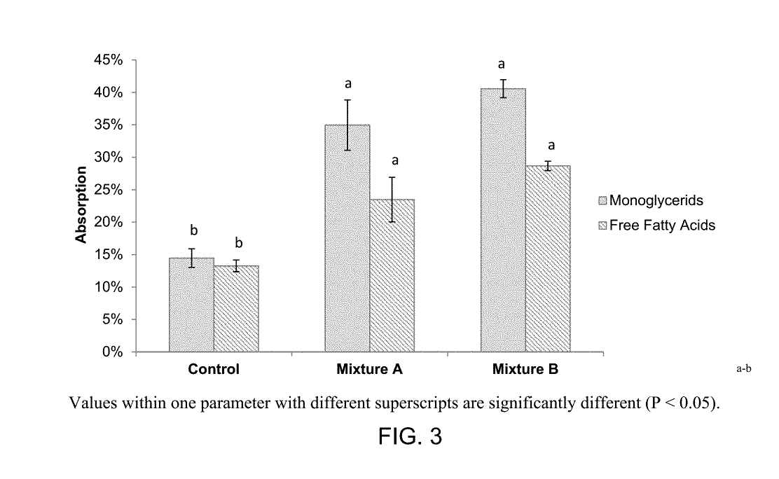

The absorption of monoglycerides and free fatty acids generated during in vitro hydrolysis of animal fat (control), animal fat with a mixture of lysolecithin, glycerol monooleate and synthetic emulsifier (Mixture A) and animal fat with a mixture of lysolecithin, glycerol monostearate and synthetic emulsifier (Mixture B) is presented in FIG. 3. The absorption of monoglycerides was significantly higher (P<0.01) in Mixture A and Mixture B (35.0% and 40.6%, respectively) than in the Control (14.5%). Similarly, the absorption of free fatty acids was significantly higher (P<0.05) in Mixture A and Mixture B (23.5% and 28.7%, respectively) than in the Control (13.3%).

Hence, Mixture A and Mixture B more than doubled (and in the case of Mixture B nearly tripled) the absorption of monoglycerides. Additionally, Mixture A and Mixture B increased the absorption of free fatty acids by more than 75%.

### Example 3: A Combination of Lysolecithin. Monoglycerides and Synthetic Emulsifier to Improve In Vivo Nutrient Digestion and Absorption

A performance trial with broilers ordered by Kemin Europa NV was carried out from Oct. 28, 2015 to Dec. 9, 2015 in the experimental poultry house at the experimental station of the Faculty of Animal Science and Biotechnology which belongs to the Banat's University of Agricultural Science and Veterinary Medicine “King Michael I of Romania” from [symbol] . The aim of the presented study was to evaluate the performance of birds fed a basal diet, a basal diet formulated with a lower metabolizable energy and birds fed the diet formulated with a lower metabolizable energy with the supplementation of two different mixtures of lysolecithin, monoglycerides and synthetic emulsifier. Simultaneously this study was used to evaluate the impact of a mixture of lysolecithin, monoglycerides and synthetic emulsifier to the carcass characteristics of the birds.

### Materials and Methods

Mixtures of Lysolecithin Monoglycerides and a Synthetic Emulsifier.

Lysolecithin (hydrolyzed soybean lecithin with a total lysophospholipid content of 124.9 g/kg), glycerol monooleate (fatty acid with 18 carbon atoms and one double bond; Iodine value of 75.8 g I₂/100 g), glycerol monostearate (fatty acid with 18 carbon atoms without double bonds; Iodine value of 0.6 g I₂/100 g) and synthetic emulsifier (Ethoxylated castor oil containing on average 40 ethylene oxide groups and with a HLB value of 12.5) were used to prepare two mixtures, indicated as Mixture A and Mixture B (Table 3), were prepared by first accurately weighing the lysolecithin, monoglycerides and synthetic emulsifier together. Next, the liquid mixtures were heated to 60° C. and stirred at approximately 250 RPM for 30 minutes before they were applied on a dry carrier (Table 3).

TABLE 3
Overview of experimental feed additives

| | Active component (g) | | | |
|---|---|---|---|---|
| | | | Synthetic | Carrier |
| Mixture | Lysolecithin | Monoglyceride | emulsifier | (g) |
| Mixture A | 300 | 50 glycerol | 5 | 645 |
| | | monooleate | | |
| Mixture B | 300 | 50 glycerol | 5 | 645 |
| | | monostearate | | |

Diets and Dietary Treatments.

The diets were formulated with corn as the principal cereal and with soybean meal as the major protein source. Two basal diets were formulated: a basal diet fulfilling all dietary requirements (T1; positive control) and a basal diet with lower Metabolizable Energy (T2; negative control; 60 kcal/kg lower in metabolizable energy in starter and 80 kcal/kg lower in metabolizable energy in grower and finisher). The global compositions of the basal starter (0-14 days), grower (15-35 days) and finisher (35-42 days) diets are presented in Table 4. All diets also contained a commercial enzyme blend with phytase (KEMZYME® Plus P Dry 500 g/ton, Kemin Europa NV, Herentals, Belgium).

For the basal diet with a lower metabolizable energy, first a single batch of feed (both for starter, grower and finisher) was made so that the quantitative composition of the experimental diets was exactly the same for treatments T2, T3 and T4 (Table 5). Next, the basal diets with a lower metabolizable energy were each divided into equal batches and successively mixed in a small mixer with the different premixes in order to produce the dietary treatments: T2, negative control; T3, negative control with 500 ppm of Mixture A on top; T4, negative control with 500 ppm of Mixture B on top.

TABLE 4
Ingredients and nutrient composition of the experimental starter, grower and finisher
diets.

| | | | | Basal diet with reduced | | |
|---|---|---|---|---|---|---|
| | Basal diet | | | metabolizable energy | | |
| Item (g/kg, unless noted) | starter | grower | finisher | starter | grower | finisher |
| Nutrient | | | | | | |
| Corn | 360.4 | 382.1 | 405.4 | 360.4 | 390.5 | 416.2 |
| Soybean meal (44% CP) | 385.0 | 331.0 | 295.5 | 384.0 | 334.7 | 295.5 |
| Wheat | 150.0 | 150.0 | 150.0 | 150.0 | 150.0 | 150.0 |
| Lard | 45.0 | 57.0 | 65.0 | 37.0 | 43.0 | 51.4 |
| Sunflower meal (34% CP) | 20.0 | 44.0 | 50.0 | 20.0 | 33.0 | 41.0 |
| Limestone | 13.5 | 12.1 | 12.0 | 13.5 | 13.0 | 12.0 |
| Wheat bran | 0.0 | 0.0 | 0.0 | 9.0 | 12.0 | 11.8 |
| Monocalcium phosphate | 8.0 | 7.5 | 7.0 | 8.0 | 7.5 | 7.0 |
| Vitamin and mineral premix | 5.0 | 5.0 | 5.0 | 5.0 | 5.0 | 5.0 |
| Lysine HCl | 3.8 | 3.2 | 2.8 | 3.8 | 3.2 | 2.8 |
| Methionine | 3.4 | 2.8 | 2.0 | 3.4 | 2.8 | 2.0 |
| NaHCO3 | 2.0 | 2.0 | 2.0 | 2.0 | 2.0 | 2.0 |
| NaCl | 1.9 | 1.9 | 2.0 | 1.9 | 1.9 | 2.0 |
| Threonine | 1.5 | 0.9 | 0.8 | 1.5 | 0.9 | 0.8 |
| KEMZYME ® Plus P Dry | 0.5 | 0.5 | 0.5 | 0.5 | 0.5 | 0.5 |
| Calculated nutrient content | | | | | | |
| Crude protein | 221.2 | 205.5 | 192.8 | 225.2 | 106.3 | 192.8 |
| AMEn (kcal/kg) | 3,063 | 3,109 | 3,143 | 3,005 | 3,027 | 3,064 |

CP: Crude protein;
AMEn: Apparent Metabolizable Energy

TABLE 5
Overview of the dietary treatments

| Treatment | | Diet | Feed additive |
|---|---|---|---|
| T1 | Positive control | Basal diet | / |
| T2 | Negative control | Basal diet with reduced | / |
| | | metabolizable energy | |
| T3 | Mixture A | Basal diet with reduced | 500 ppm |
| | | metabolizable energy | Mixture A |
| T4 | Mixture B | Basal diet with reduced | 500 ppm |
| | | metabolizable energy | Mixture B |

Birds and Management.

The broiler performance trial was performed at Banat's University of Agricultural Science and Veterinary Medicine ( [symbol] , Romania). The birds were housed in the poultry experimental facility in 36 floor pens with each an available surface of 800 cm². A total of 288 day-old male Ross 308 broilers were housed with eight birds per pen. Each dietary treatment was replicated nine times. Replicates (pens) were allocated to the treatments for a homogeneous distribution of treatments within the room. Immediately after arrival, birds were examined by a veterinarian responsible for animal welfare and selected by weight and assigned to the treatments in order to achieve maximum possible homogeneity within each group and minimum differences between all trial groups. A dynamic ventilation and heating system provided optimal poultry house temperature and ventilation. During the whole trial period a lighting scheme of 23 hours light and 1 hour dark was used. Feed was provided ad libitum by feed mangers (1 per pen). Birds were fed mash diets with the three phase feeding system (starter, grower and finisher). Drinking water was provided ad libitum by an internal water system network. Birds were reared according to the Recommendations 526/2007 CE. Twice daily, animals and housing facilities were inspected for the general health status, constant feed and water supply as well as temperature and ventilation, dead birds, and unexpected events.

Measurements and Recordings.

In order to determine performance parameters, the average body weight (ABW) was recorded in each pen at start and after 14 days of age and the feed intake was recorded between 0 and 14 days. Daily mortality and cullings were recorded per pen.

At the end of the rearing period (42 days of age), from treatments T1, T2 and T3 (Positive control, Negative control and Mixture A, respectively) two chickens per pen were sacrificed. The live weight of the birds was first recorded. The birds were then processed according to standard slaughter procedures and the weight of the whole carcass (eviscerated), the breast (with bone) and the abdominal fat pad was recorded.

Calculations and Statistical Analyses.

The average daily gain (ADG) and feed conversion ratio (FCR) were calculated for 0-14 days (starter period). ADG (g/bird/day) was calculated by subtracting the average body weight of the pen at the beginning of the measurement period (at day 0) from the average body weight at the end of that measurement period (at day 14) and dividing this value by the number of days in that measurement period (14 days). The FCR was calculated by dividing the average feed intake (g/bird/day) of the period by the ADG (g/bird/day) of the period. Carcass yield, breast yield and abdominal fat pad content were respectively calculated by dividing the weight of the carcass, breast and abdominal fat pad by the live weight of the bird.

The performance data (ABW, ADG, FCR), carcass yield, breast yield and abdominal fat pad contents were subjected to analysis of variance (ANOVA). ANOVA of the experimental treatments was done with STATGRAPHICS Centurion XVI software (Statpoint Technologies Inc., Warrenton, Va.), and means were separated by the least significant differences (LSD) procedure. All statements of significance were based on a P-value equal to or less than 0.05.

### Results

Performance.

The ABW, ADG and FCR of birds fed the Positive control diet, the Negative control diet, the Mixture A diet or the Mixture B diet are presented in Table 6. ABW and ADG were significantly higher for birds fed the Positive control, Mixture A or Mixture B diet than for those fed the Negative control diet. Addition of Mixture A or B was able to increase the ADG by 1.3 and 1.5 g/bird/day, respectively. Moreover, ABW and ADG were significantly higher (16 g/bird and 1.1 g/bird/day, respectively) for birds fed the Mixture B diet than for those fed the Positive control diet. The FCR was significantly lower in birds fed the Mixture A diet or the Mixture B diet than in birds fed the Negative control diet. Addition of Mixture A or B was able to reduce the FCR by 7 and 8 points, respectively. Hence, due to a better nutrient digestion and absorption, birds fed a diet supplemented with a mixture of lysolecithin, monoglycerides and synthetic emulsifier were able to recover an energy gap of 60 kcal/kg in the diet.

TABLE 6
Average body weight, average daily gain and feed conversion ratio

| | | Average body | | Feed |
|---|---|---|---|---|
| | | weight | Average daily gain | conversion |
| Treatment | | (g/bird) | (g/bird/day) | ratio |
| T1 | Positive control | 402^{bc} | 26.1^{bc} | 1.22^{ab} |
| T2 | Negative control | 397^{c} | 25.7^{c} | 1.26^{b} |
| T3 | Mixture A | 415^{ab} | 27.0^{ab} | 1.19^{a} |
| T4 | Mixture B | 418^{a} | 27.2^{a} | 1.18^{a} |

^{a-c}Values within columns with different superscripts are significantly different (P < 0.05)

Carcass Yield, Breast Yield and Abdominal Fat Pad.

The carcass yield, breast yield and abdominal fat pad contents of birds fed the Positive control diet, the Negative control diet or the Mixture A diet are presented in Table 7. Carcass yield and Breast yield were significantly higher in birds fed the Positive control diet or the Mixture A diet than in birds fed the Negative control diet. Moreover, the abdominal fad pad content of birds fed the Mixture A diet was significantly lower than in birds fed the Positive or the Negative control diet. The latter shows that addition of the mixture of lysolecithin, monoglycerides and synthetic emulsifier resulted in a better utilization of the absorbed nutrients for meat production.

TABLE 7
Carcass yield (%), breast yield (%) and abdominal fat pad contents (%)

| | | | | Abdominal |
|---|---|---|---|---|
| Treatment | | Carcass yield | Breast yield | fat pad content |
| T1 | Positive control | 72.8^{a} | 28.9^{a} | 1.07^{b} |
| T2 | Negative control | 71.6^{b} | 27.6^{b} | 1.19^{c} |
| T3 | Mixture A | 72.6^{a} | 28.9^{a} | 0.91^{a} |

^{a-c}Values within columns with different superscripts are significantly different (P < 0.05)

### Example 4: A Combination of Lysolecithin. Monoglycerides and Synthetic Emulsifier to Improve In Vivo Performance. Nutrient Digestion and Absorption

A performance and nutrient digestibility trial with broilers was carried out in the experimental poultry house of the Laboratory of Animal Husbandry which belongs to the Faculty of Veterinary Medicine of the Aristotle University of Thessaloniki. The aim of the presented study was to evaluate the performance and nutrient digestibility of birds fed either a basal diet fulfilling all dietary requirements, a diet formulated with a lower metabolizable energy and supplemented with lysolecithin or a diet formulated with a lower metabolizable energy and supplemented with a mixture of lysolecithin, monoglycerides and synthetic emulsifier.

### Materials and Methods

Lysolecithin and Mixture of Lysolecithin Monoglycerides and a Synthetic Emulsifier. Lysolecithin (hydrolysed soybean lecithin), glycerol monooleate (fatty acid with 18 carbon atoms and one double bond; Iodine value of 75.8 g I₂/100 g) and synthetic emulsifier (Ethoxylated castor oil containing on average 40 ethylene oxide groups and with a HLB value of 12.5) were used to prepare two treatment products, further indicated as Lysolecithin dry and Mixture dry (Table 8). For the preparation of Mixture dry, first a liquid pre-mixture was prepared. Hereto, lysolecithin, monoglycerides and synthetic emulsifier were first accurately weighed together, heated to 60° C. and stirred at approximately 250 RPM for 30 minutes. Lysolecithin or the pre-mixture were then applied on a dry carrier (Table 8) to produce the respective final treatment products (Lysolecithin dry and Mixture dry, respectively).

TABLE 8
Overview of experimental feed additives

| | Active component (g) | | | |
|---|---|---|---|---|
| Treatment | | | Synthetic | Carrier |
| product | Lysolecithin | Monoglyceride | emulsifier | (g) |
| Lysolecithin | 500 | / | / | 500 |
| dry | | | | |
| Mixture dry | 300 | 50 | 5 | 645 |

Diets and Dietary Treatments.

The diets were formulated with wheat and corn as the principal cereals and with soybean meal as the major protein source. Two basal diets were formulated: a basal diet fulfilling all dietary requirements (T1; positive control) and a basal diet with lower Metabolizable Energy (approximately 80 kcal/kg lower in metabolizable energy). The global compositions of the basal starter (0-14 days), grower (15-35 days) and finisher (35-42 days) diets are presented in Table 9. All diets also contained a commercial enzyme blend with phytase (KEMZYME® Plus P Dry 500 g/ton, Kemin Europa NV, Herentals, Belgium) and Titanium dioxide (TiO₂, at 3 g per kg of feed) as an undigestible marker for the digestibility experiment.

For the basal diet with a lower metabolizable energy, first a single batch of feed (both for starter, grower and finisher) was made so that the quantitative composition of the experimental diets was exactly the same for treatments T2 and T3 (Table 10). Next, the basal diet with a lower metabolizable energy was divided into equal batches and successively mixed in a small mixer with the different premixes in order to produce the dietary treatments T2; negative control with 500 ppm of Lysolecithin dry on top and T3; negative control with 500 ppm of Mixture on top. Taking in account the concentration of the lysolecithin and the mixture in Lysolecithin dry and Mixture dry, T2 and T3 thus delivered 250 g of lysolecithin and 177.5 g of the mixture per tonne of feed, respectively.

TABLE 9
Ingredients and nutrient composition of the experimental starter, grower and finisher
diets.

| | | | | Basal diet with reduced | | |
|---|---|---|---|---|---|---|
| | Basal diet | | | metabolizable energy | | |
| Item (g/kg, unless noted) | starter | grower | finisher | starter | grower | finisher |
| Nutrient | | | | | | |
| Wheat | 407.3 | 420.7 | 405.2 | 425.3 | 420.7 | 405.2 |
| Soybean meal (47% CP) | 300.0 | 300.0 | 260.0 | 296.0 | 300.0 | 260.0 |
| Corn | 200.0 | 197.7 | 250.0 | 200.0 | 197.7 | 250.0 |
| Herring meal | 20.0 | / | / | 20.0 | / | / |
| Limestone | 13.8 | 13.6 | 12.9 | 13.8 | 13.6 | 12.9 |
| Soybean oil | 27.0 | 30.0 | 34.0 | 15.5 | 22.0 | 24.0 |
| Palm oil | 8.0 | 15.0 | 16.5 | 5.5 | 11.5 | 13.0 |
| Wheat bran | / | / | / | / | 11.5 | 13.5 |
| Monocalcium phosphate | 7.5 | 7.2 | 6.6 | 7.5 | 7.2 | 6.6 |
| Vitamin and mineral premix | 5.0 | 5.0 | 5.0 | 5.0 | 5.0 | 5.0 |
| Methionine | 3.4 | 2.8 | 2.2 | 3.4 | 2.8 | 2.2 |
| Lysine HCl | 3.0 | 2.5 | 2.4 | 3.0 | 2.5 | 2.4 |
| Threonine | 1.4 | 1.2 | 0.9 | 1.4 | 1.2 | 0.9 |
| NaCl | 2.0 | 2.3 | 2.2 | 2.0 | 2.3 | 2.2 |
| NaHCO3 | 1.1 | 1.5 | 1.6 | 1.1 | 1.5 | 1.6 |
| KEMZYME ® Plus P Dry | 0.5 | 0.5 | 0.5 | 0.5 | 0.5 | 0.5 |
| Calculated nutrient content | | | | | | |
| Crude protein | 224.8 | 211.0 | 193.9 | 224.9 | 212.8 | 196.1 |
| Crude fat | 54.3 | 62.4 | 68.6 | 40.6 | 51.3 | 55.8 |
| U/S-ratio | 3.68 | 3.17 | 3.20 | 3.68 | 3.24 | 3.21 |
| AMEn (kcal/kg) | 3,012 | 3,053 | 3,131 | 2,938 | 2,973 | 3,036 |

CP: Crude protein;
AMEn: Apparent Metabolizable Energy;
U/S ratio: ratio of unsaturated over saturated fatty acids (no unit)

TABLE 10
Overview of the dietary treatments

| Treatment | | Diet | Feed additive |
|---|---|---|---|
| T1 | Control | Basal diet | / |
| T2 | Lysolecithin | Basal diet with reduced | 500 ppm Lysolecithin dry |
| | | metabolizable energy | |
| T3 | Mixture | Basal diet with reduced | 500 ppm Mixture dry |
| | | metabolizable energy | |

Birds, Diets and Management.

The broiler performance and digestibility trial was performed at Aristotle University of Thessaloniki (Thessaloniki, Greece). The birds were housed in a poultry facility in 24 floor pens with each an available surface of 2.0 m². A total of 408 day-old mixed sex (as hatched) Ross 308 broilers were housed with 17 birds per pen (8.5 birds per m²). Each dietary treatment was replicated eight times. Replicates (pens) were allocated to the treatments for a homogeneous distribution of treatments within the room. A dynamic ventilation and heating system provided optimal poultry house temperature and ventilation. During the whole trial period a lighting scheme of 23 hours light and 1 hour dark was used. Feed was provided ad libitum. Birds were fed mash diets with the three phase feeding system (starter, grower and finisher). Drinking water was provided ad libitum. Twice daily, animals and housing facilities were inspected for the general health status, constant feed and water supply as well as temperature and ventilation, dead birds, and unexpected events.

Sampling and Recordings.

Samples of each of the finished diets were taken immediately after feed production. At 34 days, in each pen a thick nylon mat was placed on top of the bedding material for excreta collection. Excreta were collected over a period of approximately 8 eight hours by scraping the excreta from the nylon mat. Non-excreta matters (e.g. feathers and feed particles) were removed by hand before the excreta were gathered. A homogeneous sample of the excreta retained form each pen was immediately frozen and subsequently freeze-dried. The average body weight (ABW) was recorded in each pen at start and after 14, 28 and 42 days of age and the feed intake was recorded between 0 and 14 days, 14 and 28 days and 28 and 42 days of age. Daily mortality and cullings were recorded per pen.

Chemical Analyses of Feed and Excreta.

All analyses were performed by the Aristotle University of Thessaloniki (Thessaloniki, Greece). Feed and excreta samples were analyzed for dry matter (DM), Crude protein (CP, N×6.25) and crude fat (CF) contents according to the methods of the Association of Official Analytical Chemists (AOAC, 2003). Gross energy (GE) was calculated using an adiabatic bomb calorimeter (Calorimeter System C 5000 Control, IKA®, Staufen, Germany). Determination of titanium dioxide was performed by Inductively Coupled Plasma Optical Emission Spectrometry following the procedure of van Brussel (van Bussel W., Kerkhof F., van Kessel T., Lamers H., Nous D., Verdonk H., Verhoeven B. (2010) Accurate Determination of Titanium as Titanium Dioxide for Limited Sample Size Digestibility Studies of Feed and Food Matrices by Inductively Coupled Plasma Optical Emission Spectrometry With Real-Time Simultaneous Internal Standardization. Atom. Spectrosc. 31: 81-88).

Calculations and Statistical Analyses.

The average daily gain (ADG) and feed conversion ratio (FCR) were calculated for 0 to 14 days (starter period), 15 to 28 days (grower period), 29 to 42 days (finisher period) and 0 to 42 days (whole rearing period). ADG (g/bird/day) was calculated by subtracting the ABW of each pen at the beginning of the measurement period (e.g. at day 0) from the average body weight at the end of that measurement period (e.g. at day 14) and dividing this value by the number of days in that measurement period (e.g. 14 days). The FCR was calculated by dividing the average feed intake (g/bird/day) of the period by the ADG (g/bird/day) of the period. Carcass yield, breast yield and abdominal fat pad content were respectively calculated by dividing the weight of the carcass, breast and abdominal fat pad by the live weight of the bird.

Nutrient digestibilities (DM, CP and CF) were determined by the use of the concentrations of titanium dioxide tracer in the excreta and in the feed and calculated according to Equation 1. The apparent metabolizable energy (AME) contents of the experimental diets were calculated from their respective titanium dioxide ratios and corresponding GE contents, as shown in Equation 2. The result was corrected for zero nitrogen retention by using an energy equivalent of 8.22 kcal/g nitrogen retained and provided the AMEn-value of the diet.

$$Digestibility ( \% ) = \frac{[ nutrientdiet - ( \frac{{TiO}_{2} diet}{{TiO}_{2} excreta} \times nutrientexcreta ) ]}{[ nutrientdiet ]} \times 100$$

### Equation 1.

Calculation of the apparent fecal nutrient digestibilities. Nutrientdiet and nutrientexcreta are the concentrations of the respective nutrients (dry matter, crude protein, crude fat) analyzed in the diet and excreta samples (g/kg), and TiO₂diet and TiO₂excreta are the concentrations of titanium dioxide analyzed in the diet and excreta samples (g/kg).

$$AME ( kcal \text{/} kg ) = GEdiet - [ GEexcreta \times ( \frac{{TiO}_{2} diet}{{TiO}_{2} excreta} ) ]$$

### Equation 2.

Calculation of the apparent metabolizable energy contents of the experimental diets. GEdiet and GEexcreta are the analyzed gross energy values of the diet and excreta samples (kcal/kg).

The performance (ABW, ADG, FCR) and digestibility data (DM, CP and CF digestibility and AMEn) carcass yield, breast yield and abdominal fat pad contents were subjected to analysis of variance (ANOVA). ANOVA of the experimental treatments was done with STATGRAPHICS Centurion XVI software (Statpoint Technologies Inc., Warrenton, Va.), and means were separated by the least significant differences (LSD) procedure. A pen with 17 animals was the experimental unit and each of the three treatments was replicated eight times (eight pens per treatment). All statements of significance were based on a P-value equal to or less than 0.05.

### Results

Performance.

Table 11 provides the average body weight (g/bird) at 0, 14, 28 and 42 days of age of birds fed a basal diet (Control), a basal diet with reduced metabolizable energy content supplemented with only lysolecithin (Lysolecithin, 250 g/tonne on top) or a diet with reduced metabolizable energy content supplemented with a mixture of lysolecithin, monoglycerides and synthetic emulsifier (Mixture, 177.5 g/tonne on top). Despite the reduced energy content of the Lysolecithin and Mixture diets compared to the control diet (between 74 and 95 kcal per kg of feed, Table 9), no significant differences in the intermediate and final ABW of the broilers was found (Table 11). The highest final ABW was observed for birds fed the mixture diet (2856 g/bird vs. 2849 g/bird).

TABLE 11
Average body weight (g/bird) at 0, 14, 28 and 42 days of age

Average body Weight

| Treatment | | Day 0 | Day 14 | Day 28 | Day 42 |
|---|---|---|---|---|---|
| T1 | Control | 44.44 | 403.15 | 1399.17 | 2848.54 |
| T2 | Lysolecithin | 44.88 | 376.15 | 1378.50 | 2849.15 |
| T3 | Mixture | 45.00 | 391.06 | 1402.49 | 2856.14 |

The average daily gain (g/bird/day) for the starter (0-14 days), grower (15-28 days), finisher (29-42 days) and whole rearing (0-42 days) period of birds fed a basal diet (Control), a basal diet with reduced metabolizable energy content supplemented with only lysolecithin (Lysolecithin, 250 g/tonne on top) or a diet with reduced metabolizable energy content supplemented with a mixture of lysolecithin, monoglycerides and synthetic emulsifier (Mixture, 177.5 g/tonne on top) are presented in Table 12. Feed conversion ratio for the starter (0-14 days), grower (15-28 days), finisher (29-42 days) and whole rearing (0-42 days) period of birds fed a basal diet (Control), a basal diet with reduced metabolizable energy content supplemented with only lysolecithin (Lysolecithin, 250 g/tonne on top) or a diet with reduced metabolizable energy content supplemented with a mixture of lysolecithin, monoglycerides and synthetic emulsifier (Mixture, 177.5 g/tonne on top) are presented in Table 13. In accordance with the results of the ABW of birds, no significant differences in ADG or FCR were observed between any of the treatments. Hence, despite the reduced energy content of the Lysolecithin and Mixture diets, birds fed these diets were still able to meet the stringent performance standards as set with the Control diet.

TABLE 12
Average daily gain (g/bird/day)

Average daily gain

| | | | | | Whole |
|---|---|---|---|---|---|
| Treatment | | Starter | Grower | Finisher | rearing |
| T1 | Control | 25.62 | 71.14 | 103.53 | 66.76 |
| T2 | Lysolecithin | 23.66 | 71.60 | 105.05 | 66.77 |
| T3 | Mixture | 24.72 | 72.24 | 103.83 | 66.93 |

TABLE 13
Feed conversion ratio (FCR)

FCR

| | | | | | Whole |
|---|---|---|---|---|---|
| Treatment | | Starter | Grower | Finisher | rearing |
| T1 | Control | 1.52 | 1.46 | 1.79 | 1.64 |
| T2 | Lysolecithin | 1.66 | 1.40 | 1.74 | 1.61 |
| T3 | Mixture | 1.50 | 1.48 | 1.77 | 1.63 |

Nutrient Digestibility.

The nutrient digestibility coefficients (%) (DM, CP, CF) and apparent metabolizable energy corrected for zero nitrogen retention (AMEn, kcal/kg) determined at 35 days of age of birds fed a basal diet (Control), a basal diet with reduced metabolizable energy content supplemented with only lysolecithin (Lysolecithin, 250 g/tonne on top) or a diet with reduced metabolizable energy content supplemented with a mixture of lysolecithin, monoglycerides and synthetic emulsifier (Mixture, 177.5 g/tonne on top) are presented in Table 14. In contrast to the performance parameters, significant differences between treatments were observed for the DM and CP digestibility as well as for the AMEn. DM digestibility was significantly higher in birds fed the Mixture diet compared to those fed either the control diet or Lysolecithin diet. CP digestibility was significantly higher in birds fed the Mixture when compared to the Lysolecithin diet. Though not significant, similar observations were made for the CF digestion. The highest CF digestion was observed with birds fed the Mixture diet (89.68%), followed by those fed the Lysolecithin diet (87.57%) and Control diet (85.52%), respectively. The improved digestibility of nutrients was also reflected in a significantly higher AMEn that was observed for birds fed the Mixture diet (3,513 kcal/kg) when compared to those fed either the control diet or Lysolecithin diet (3,220 and 3,255 kcal/kg, respectively).

TABLE 14
Digestibility coefficients (%) and apparent metabolizable energy (kcal/kg)

| | | Digestibility coefficient | | | |
|---|---|---|---|---|---|
| Treatment | | Dry matter | Crude protein | Crude fat | AMEn |
| T1 | Control | 69.74^{b} | 66.06^{ab} | 85.52 | 3,220^{b} |
| T2 | Lysolecithin | 69.71^{b} | 58.32^{b} | 87.57 | 3,255^{b} |
| T3 | Mixture | 75.56^{a} | 70.97^{a} | 89.68 | 3,513^{a} |

^{a-b}Values within columns with different superscripts are significantly different (P < 0.05)

As reflected by the performance data, Lysolecithin and the Mixture were able to recover the energy gap (between 74 and 95 kcal per kg of feed) in their diets, leading to the same performance of birds fed with less energy in the diet. The performance is likely maintained by the improved nutrient digestibility that was observed.

Moreover, although higher quantities of lysolecithin were supplied in the Lysolecithin diet (250 versus 150 g lysolecithin per tonne of feed for the Lysolecithin and Mixture diet, respectively), the mixture was more successful in improving the DM and CP digestibility. DM and CP digestibility were respectively 5.85% and 12.65% higher in birds fed the Mixture diet compared to those fed the Lysolecithin diet. Though not significant, CF digestion was also 2.11% and 4.16% higher in birds fed the Mixture diet when compared to those fed the Lysolecithin or Control diet, respectively. In addition, the AMEn was also 258 and 293 kcal/kg higher in birds fed the Mixture diet when compared to those fed the Lysolecithin or Control diet, respectively. Taken in account the already reduced energy content of the diet, the Mixture was thus very successful in improving the nutrient and energy use of broilers, hereby exceeding the benefits of supplementing only lysolecithin.

### Example 5: A Combination of Lysolecithin. Monoglycerides and Synthetic Emulsifier to Improve Meat Yield

A trial with broilers was carried out in the experimental poultry house of Kemin Industries South Asia Private Limited. The aim of the presented study was to evaluate the meat yield of birds fed either a basal diet fulfilling all dietary requirements, a diet formulated with a lower metabolizable energy or a diet formulated with a lower metabolizable energy and supplemented with a mixture of lysolecithin, monoglycerides and synthetic emulsifier.

### Materials and Methods

Mixture of Lysolecithin Monoglycerides and a Synthetic Emulsifier.

Lysolecithin (hydrolysed soybean lecithin), glycerol monooleate (fatty acid with 18 carbon atoms and one double bond; Iodine value of 75.8 g I₂/100 g) and synthetic emulsifier (Ethoxylated castor oil containing on average 40 ethylene oxide groups and with a HLB value of 12.5) were used to prepare the treatment product, presented in Table 15 as the “Mixture dry” For the preparation the Mixture dry, first a liquid pre-mixture was prepared in which monoglycerides and synthetic emulsifier were first accurately weighed together, heated to 60° C. and stirred at approximately 250 RPM for 30 minutes. The pre-mixture was then applied on a dry carrier, also presented in Table 15, to produce the Mixture dry.

TABLE 15
Overview of experimental feed additive

| | Active component (g) | | | |
|---|---|---|---|---|
| Treatment | | | Synthetic | Carrier |
| product | Lysolecithin | Monoglyceride | emulsifier | (g) |
| Dry Mixture | 300 | 50 | 5 | 645 |

Diets and Dietary Treatments.

The diets were formulated with corn as the principal cereal and with soybean meal as the major protein source. Two basal diets were formulated: a basal diet fulfilling all dietary requirements (T1; positive control) and a basal diet with lower Metabolizable Energy (approximately 100 kcal/kg lower in metabolizable energy). The global compositions of the basal starter (0-14 days), grower (15-28 days) and finisher (29-42 days) diets are presented in Table 16. All diets also contained a toxin binder (Toxfin™, 1 kg/ton, Kemin Industries South Asia Private Limited, Gummudipoondi, Tamil, India), a probiotic (CLOSTAT™, 500 g/ton, Kemin Industries South Asia Private Limited, Gummudipoondi, Tamil, India) and a commercial enzyme blend (KEMZYME® XPF, 250 g/ton, Kemin Industries South Asia Private Limited, Gummudipoondi, Tamil, India).

TABLE 16
Ingredients and nutrient composition of the experimental starter, grower and finisher
diets

| | | | | Basal diet with reduced | | |
|---|---|---|---|---|---|---|
| | Basal diet | | | metabolizable energy | | |
| Item (g/kg, unless noted) | starter | grower | finisher | starter | grower | finisher |
| Nutrient | | | | | | |
| Corn | 527.30 | 553.40 | 576.50 | 534.00 | 578.70 | 601.80 |
| Soybean meal (45% CP) | 341.60 | 292.80 | 256.50 | 348.90 | 289.30 | 253.00 |
| Rice polish | 40.00 | 45.00 | 45.00 | 51.60 | 45.00 | 45.00 |
| Meat & bone meal (44% CP) | 30.00 | 35.00 | 40.00 | 15.00 | 35.00 | 40.00 |
| Rice bran oil | 20.30 | 28.70 | 37.70 | 4.00 | 6.90 | 16.00 |
| Mustard deoiled cake | 10.00 | 20.0 | 25.00 | 10.00 | 20.0 | 25.00 |
| Dicalcium phosphate | 6.80 | 4.25 | 1.09 | 10.00 | 4.20 | 1.02 |
| CaCO₃ | 6.30 | 4.40 | 3.00 | 8.97 | 4.50 | 3.07 |
| Methionine | 2.90 | 2.37 | 2.08 | 2.97 | 2.32 | 2.04 |
| Lysine | 2.32 | 2.20 | 1.78 | 2.32 | 2.22 | 1.82 |
| Threonine | 0.62 | 0.50 | 0.46 | 0.62 | 0.50 | 0.45 |
| NaCl | 2.21 | 1.87 | 1.92 | 2.32 | 1.84 | 1.90 |
| NaHCO₃ | 1.87 | 1.80 | 1.18 | 2.10 | 1.82 | 1.20 |
| Choline chloride (60%) | 1.00 | 1.00 | 1.00 | 1.00 | 1.00 | 1.00 |
| Toxfin ™ | 1.00 | 1.00 | 1.00 | 1.00 | 1.00 | 1.00 |
| CLOSTAT ™ | 0.50 | 0.50 | 0.50 | 0.50 | 0.50 | 0.50 |
| KEMZYME ® XPF | 0.25 | 0.25 | 0.25 | 0.25 | 0.25 | 0.25 |
| Other^{a} | 4.70 | 4.70 | 4.70 | 4.70 | 4.70 | 4.70 |
| Calculated nutrient content | | | | | | |
| Crude protein | 213.7 | 200.7 | 190.6 | 213.0 | 201.0 | 191.0 |
| Crude fat | 54.0 | 64.0 | 74.0 | 37.3 | 44.0 | 54.3 |
| AMEn (kcal/kg) | 2,900 | 2,980 | 3,060 | 2,800 | 2,880 | 2,960 |

CP: Crude protein;
AMEn: Apparent Metabolizable Energy;
^{a}Other ingredients are: Feed acidifier (0.5 g/kg), Mold inhibitor (1.0 g/kg), Betaine (0.5 g/kg), Vitamin and mineral premix (0.5 g/kg), Liver tonics (0.5 g/kg), Anticoccidial (0.5 g/kg), Trace minerals (0.5 g/kg), Antibiotic growth promotor (0.5 g/kg), Antioxidant (0.1 g/kg) and Phytase (0.1 g/kg)

For the basal diet with a lower metabolizable energy, first a single batch of feed (both for starter, grower and finisher) was made so that the quantitative composition of the experimental diets was exactly the same for treatments T2 and T3, shown in Table 17. Next, the basal diet with a lower metabolizable energy was divided into equal batches and successively mixed in a small mixer with the different premixes in order to produce the dietary treatments T2; negative control and T3; negative control with 500 ppm of the Dry Mixture on top.

TABLE 17
Overview of the dietary treatments

| Treatment | | Diet | Feed additive |
|---|---|---|---|
| T1 | Positive Control | Basal diet | / |
| T2 | Negative Control | Basal diet with reduced | / |
| | | metabolizable energy | |
| T3 | Mixture | Basal diet with reduced | 500 ppm Mixture dry |
| | | metabolizable energy | |

Birds, Diets and Management.

The broiler trial was performed at the experimental poultry house of Kemin Industries South Asia Private Limited (Gummudipoondi, Tamil, India). The birds were housed in the poultry facility in 18 floor pens. A total of 408 day-old mixed sex (as hatched) Vencobb 430 broilers were housed with 12 birds per pen. Each dietary treatment was replicated six times. Replicates (pens) were allocated to the treatments for a homogeneous distribution of treatments within the room. The poultry facility consists of an open housing system following the temperature and lighting of the environment. Feed was provided ad libitum. Birds were fed mash diets with the three-phase feeding system (starter, grower and finisher). Drinking water was provided ad libitum. Twice daily, animals and housing facilities were inspected for the general health status, constant feed and water supply as well as temperature and ventilation, dead birds, and unexpected events.

Sampling and Recordings.

At 40 days, a randomly selected male broiler from each pen was sacrificed. The weight of each bird was recorded. Each bird was then processed according to standard slaughter procedures and the weight of the meat tissue was recorded.

Calculations and Statistical Analyses.

Meat yields were calculated by dividing the weight of the weight of the meat tissue by the respective live weight of the bird. Meat yield data were then subjected to analysis of variance (ANOVA). ANOVA of the experimental treatments was done with STATGRAPHICS Centurion XVI software (Statpoint Technologies Inc., Warrenton, Va.), and means were separated by the least significant differences (LSD) procedure. A pen with 12 animals was the experimental unit and each of the three treatments was replicated six times (six pens per treatment). All statements of significance were based on a P-value equal to or less than 0.05.

### Results

Meat Yield.

Table 18 provides the meat yield (%) at 40 days of age of birds fed a basal diet (Positive control), a basal diet with reduced metabolizable energy content (Negative Control) or a diet with reduced metabolizable energy content supplemented with a mixture of lysolecithin, monoglycerides and synthetic emulsifier (Mixture).

TABLE 18
Meat yield (% of body weight) at 40 days of age

| Treatment | | Meat yield |
|---|---|---|
| T1 | Positive control | 63.1^{ab} |
| T2 | Negative control | 61.4^{b} |
| T3 | Mixture | 63.7^{a} |

^{a-b}Values with different superscripts are significantly different (P < 0.05)

Birds fed the basal diet with reduced metabolizable energy content (T2, Negative Control) had a numerically lower meat yield compared to birds fed the basal diet (T1, Positive control). However, birds fed the Mixture (T3) had a significantly higher meat yield compared to those fed the negative control diet (T2). Furthermore, the highest meat yield was observed for birds fed the Mixture (T3). Hence, despite the reduced energy content, birds fed the Mixture diet were able to produce the highest meat yield due to the addition of the Mixture dry.

### Example 6: A Combination of Lysolecithin. Monoglycerides and Synthetic Emulsifier to Improve the Feed Conversion Ratio

A performance with broilers was carried out in the experimental poultry house of Southern Poultry Research, Athens, Ga. (USA). The aim of the presented study was to evaluate the body weight gain and feed conversion of birds fed either a basal diet fulfilling all dietary requirements, a diet formulated with a lower metabolizable energy or a diet formulated with a lower metabolizable energy and supplemented with a mixture of lysolecithin, monoglycerides and synthetic emulsifier.

### Materials and Methods

Mixture of Lysolecithin Monoglycerides and a Synthetic Emulsifier.

Lysolecithin (hydrolysed soybean lecithin), glycerol monooleate (fatty acid with 18 carbon atoms and one double bond; Iodine value of 75.8 g I₂/100 g) and synthetic emulsifier (Ethoxylated castor oil containing on average 40 ethylene oxide groups and with a HLB value of 12.5) were used to prepare treatment product, further indicated as Mixture dry, as shown in Table 19. For the preparation of Mixture dry, first a liquid pre-mixture was prepared. Hereto, lysolecithin, monoglycerides and synthetic emulsifier were first accurately weighed together, heated to 60° C. and stirred at approximately 250 RPM for 30 minutes. The pre-mixture was then applied on a dry carrier, also shown in Table 19, to produce the Mixture dry.

TABLE 19
Overview of experimental feed additives

| | Active component (g) | | | |
|---|---|---|---|---|
| Treatment | | | Synthetic | Carrier |
| product | Lysolecithin | Monoglyceride | emulsifier | (g) |
| Mixture dry | 300 | 50 | 5 | 645 |

Diets and Dietary Treatments.

The diets were formulated with corn as the principal cereal and with soybean meal as the major protein source. Two basal diets were formulated: a basal diet fulfilling all dietary requirements (T1; positive control) and a basal diet with lower Metabolizable Energy (approximately 120 kcal/kg lower in metabolizable energy). The global compositions of the basal starter (0-21 days), grower (22-35 days) and finisher (36-42 days) diets are presented in Table 20. All diets also contained a commercial enzyme (Hostazym® X 1.0, Huvepharma Inc., St. Louis, USA) and a phytase (Ronozyme® HiPhos 2700 GT, DSM Nutritional Products, Ames, USA), an anti-coccidial drug (Bio-Cox®, Alpharma LLC, New Jersey, USA) and a bacitracin (BMD® 50, Zoetis Inc., Kalamazoo, USA).

TABLE 20
Ingredients and nutrient composition of the experimental starter, grower and finisher
diets

| | | | | Basal diet with reduced | | |
|---|---|---|---|---|---|---|
| | Basal diet | | | metabolizable energy | | |
| Item (g/kg, unless noted) | starter | grower | finisher | starter | grower | finisher |
| Nutrient | | | | | | |
| Corn | 554.6 | 605.2 | 653.0 | 536.1 | 604.8 | 650.2 |
| Dehulled soybean meal | 335.0 | 286.1 | 240.5 | 326.0 | 253.3 | 211.5 |
| De-oiled DDGS | 40.0 | 40.0 | 40.0 | 40.0 | 40.0 | 40.0 |
| Poultry fat | 24.3 | 22.8 | 21.6 | 20.0 | 20.0 | 20.0 |
| Meat and bone meal (55% CP) | 20.0 | 20.0 | 20.0 | 35.3 | 43.6 | 42.2 |
| CaCO₃ | 9.9 | 8.2 | 7.9 | 13.2 | 11.2 | 10.1 |
| Dicalcium phosphate | 8.3 | 7.4 | 6.5 | 9.2 | 7.9 | 7.5 |
| NaCl | 4.2 | 4.2 | 4.2 | 9.6 | 8.1 | 7.1 |
| Wheat bran | 0.0 | 0.0 | 0.0 | 0.2 | 0.2 | 0.2 |
| Methionine | 2.8 | 2.1 | 2.1 | 4.2 | 4.2 | 4.2 |
| Lysine | 1.0 | 0.9 | 1.1 | 2.7 | 2.2 | 2.1 |
| Threonine | 0.0 | 0.0 | 0.0 | 0.0 | 0.2 | 0.3 |
| Trace Mineral premix | 0.8 | 0.8 | 0.8 | 0.8 | 0.8 | 0.8 |
| Vitamin premix | 0.7 | 0.7 | 0.7 | 0.7 | 0.7 | 0.7 |
| BMD ® 50 | 0.5 | 0.5 | 0.5 | 0.5 | 0.5 | 0.5 |
| Bio-Cox ® | 0.5 | 0.5 | 0.5 | 0.5 | 0.5 | 0.5 |
| Hostazym ® X 1.0 | 0.5 | 0.5 | 0.5 | 0.5 | 0.5 | 0.5 |
| Ronozyme ® HiPhos | 0.2 | 0.2 | 0.2 | 0.2 | 0.2 | 0.2 |
| Calculated nutrient content | | | | | | |
| Crude protein | 230.0 | 210.0 | 192.0 | 229.2 | 201.6 | 185.0 |
| Crude fat | 50 | 50 | 50 | 40 | 40 | 40 |
| AMEn (kcal/kg) | 3,084 | 3,125 | 3,160 | 2,964 | 3,005 | 3,040 |

CP: Crude Protein;
DDGS: Dried Distillers Grains with Solubles;
AMEn: Apparent Metabolizable Energy

For the basal diet with a lower metabolizable energy, first a single batch of feed (both for starter, grower and finisher) was made so that the quantitative composition of the experimental diets was exactly the same for treatments T2 and T3 presented in Table 21. Next, the basal diet with a lower metabolizable energy was divided into equal batches and successively mixed in a small mixer with the different premixes in order to produce the dietary treatments T2; negative control and T3; negative control with 500 ppm of Mixture dry on top.

TABLE 21
Overview of the dietary treatments

| Treatment | | Diet | Feed additive |
|---|---|---|---|
| T1 | Positive Control | Basal diet | / |
| T2 | Negative Control | Basal diet with reduced | / |
| | | metabolizable energy | |
| T3 | Mixture | Basal diet with reduced | 500 ppm Mixture dry |
| | | metabolizable energy | |

Birds, Diets and Management.

The broiler performance trial was performed at experimental poultry facility of Southern Poultry Research, Inc. (Brock Road, Ga., USA). The broiler house is divided into pens of equal size arranged along a central aisle. The birds were housed in 48 floor pens. A total of 2496 day-old male Cobb 500 broilers were housed with 52 birds per pen (±11 birds per m²). Each dietary treatment was replicated 16 times. Replicates (pens) were allocated to the treatments for a homogeneous distribution of treatments within the room using a randomized block design. Feed and drinking water were provided ad libitum. Birds were fed with the three-phase feeding system (starter, grower and finisher). Birds were fed a crumbled diet in the starter phase and pelleted diets in the grower and finisher phases. From day 1 until day 7, feed was supplied on a tray placed on the litter of each pen. Thereafter, the diets were provided from one tube feeder per pen. Twice daily, animals and housing facilities were inspected for the general health status, constant feed and water supply as well as temperature and ventilation, dead birds, and unexpected events.

Recordings.

The average bird weight per pen (g/bird) was recorded at the start of the beginning (Day 0) and at the end (Day 42) of the trial. Feed consumption (g) per pen was recorded for the whole rearing period.

Calculations and Statistical Analyses.

The average daily gain (ADG; g/bird/day) and feed conversion ratio (FCR) were calculated for the whole rearing period (0 to 42 days). ADG and FCR data were then subjected to analysis of variance (ANOVA) using the JMP® software package (SAS Inc., Cary, N.C., USA), with comparison of means by Student's t (P<0.05). A pen with 54 animals was the experimental unit and each of the three treatments was replicated 16 times (16 pens per treatment). All statements of significance were based on a P-value equal to or less than 0.05.

### Results

Performance.

Table 22 provides the average daily gain (g/bird/day) and FCR over the whole rearing period of birds fed a basal diet (T1; Positive control), a basal diet with reduced metabolizable energy content (T2; Negative control) or a diet with reduced metabolizable energy content supplemented with a mixture of lysolecithin, monoglycerides and synthetic emulsifier (T3; Mixture). The ADG of birds fed the basal diet with reduced metabolizable energy content (T2, Negative Control) was significantly lower compared to the ADG of birds fed the basal diet (T1, Positive control). Despite the reduced energy content, the ADG of birds fed the Mixture (T3) was not significantly lower compared to the ADG of birds fed the positive control diet (T1). Moreover, birds fed the negative control diet (T2) had a significantly higher FCR than those fed the positive control diet. In contrast, despite the reduced energy content, the FCR of birds fed the Mixture (T3) was not significantly lower compared to the FCR of birds fed the positive control diet (T1).

TABLE 22
Average daily gain (ADG; g/bird/day) and Feed conversion ratio (FCR)

| Treatment | | ADG | FCR |
|---|---|---|---|
| T1 | Positive control | 55.5^{a} | 1.64^{a} |
| T2 | Negative control | 53.3^{b} | 1.71^{b} |
| T3 | Mixture | 54.1^{ab} | 1.66^{a} |

^{a-b}Values with different superscripts are significantly different (P < 0.05)

Hence, due to a better nutrient digestion and absorption, birds fed a diet supplemented with a mixture of lysolecithin, monoglycerides and synthetic emulsifier were able to recover an energy gap of 120 kcal/kg in the diet.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

We claim:

1. An animal feed supplement comprising a combination of lysolecithin or purified lysophospholipid-rich compounds, monoglycerides and at least one synthetic emulsifier.

2. An animal feed supplement according to claim 1, wherein the supplement is added to an animal feed in an amount sufficient to enhance nutrient digestibility, absorption or utilization of feed.

3. An animal feed supplement according to claim 1, wherein the combination comprises lysolecithins or purified lysophospholipid-rich compounds in an amount ranging from 15 to 1500 grams per tonne of feed.

4. An animal feed supplement according to claim 3, wherein the combination further comprises monoglycerides in an amount ranging from 2.5 to 250 grams per tonne of feed.

5. An animal feed supplement according to claim 4, wherein the combination further comprises synthetic emulsifiers in an amount ranging from 0.25 to 25 grams per tonne of feed.

6. An animal feed supplement according to claim 1, wherein the animal feed supplement can replace an energy deficiency of at least 60 kcal/kg of animal feed.

7. An animal feed supplement according to claim 1, wherein the animal feed supplement can replace an energy deficiency of at least 75 kcal/kg of animal feed.

8. An animal feed supplement according to claim 1, wherein the animal feed supplement can replace an energy deficiency of at least 100 kcal/kg of animal feed.

9. A method for preparing an animal feed supplement comprising adding a composition to the animal feed, wherein the composition comprises lysolecithin, monoglycerides, and synthetic emulsifiers sufficient to enhance nutrient digestibility, absorption or utilization of feed.

10. The method of claim 9, wherein the method comprises applying the animal feed supplement to the feed batch or combining the animal feed supplement into a premix or preparations of premixes.

11. The method according to claim 9, wherein the animal feed supplement is a liquid.

12. The method according to claim 10, wherein the animal feed supplement is applied to a suitable carrier and administered as a dry product.
